(19) United States
(12) Patent Application Publication
(10) Pub. No.: US 2005/0156925 A1
(43) Pub. Date: Jul. 21, 2005

(54) Graphical user interface for pre-boot operating environment

(76) Inventors: Ryan P. Fong, Castro Valley, CA (US); Rogerio Timmers, Porto Alegre (BR); Claudia Abrahao Pereira, Porto Alegre (BR); Andre Gobbi Farina, Porto Alegre (BR); Sandro Rafaeli, Porto Alegre (BR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/758,847

(22) Filed: Jan. 16, 2004

(51) Int. Cl. G06F 7/00

(52) U.S. Cl. 345/418; 707/1

(57) ABSTRACT

A graphical user interface of an apparatus in one example is employable for one or more file management procedures of a pre-boot operating environment employable with a command line interface.

### BACKGROUND

Previous operating systems employed a command line interface for interactions with a user and computer hardware components. The command line interface received typed commands from the user and executed a procedure that corresponded to the typed commands, for example, listing a directory tree or accessing a file.

Present operating systems use graphical user interfaces to simplify interactions with the user and computer hardware components. The graphical user interface employs a shell with graphics and/or text to provide a more user-friendly and efficient interface to the hardware components. For example, the graphical user interface employs menus, mouse inputs, hotkeys, and/or abbreviated keyboard inputs to reduce a number of keystrokes for executing a procedure. The graphical user interface also supports user interface controls, for example, checkboxes, combo boxes, progress bars, tabs, and window frames.

### SUMMARY

The invention in one implementation comprises an apparatus. The apparatus comprises a graphical user interface employable for one or more file management procedures of a pre-boot operating environment employable with a command line interface.

Another implementation of the invention comprises a method. A graphical user interface is invoked through a command line interface for one or more file management procedures of a pre-boot operating environment.

Yet another implementation of the invention comprises an article. The article comprises one or more computer-readable signal-bearing media. The article includes means in the one or more media for invoking a graphical user interface through a command line interface for one or more file management procedures of a pre-boot operating environment.

The invention in another implementation comprises an apparatus. The apparatus comprises means for invoking a graphical user interface through a command line interface for one or more file management procedures of a pre-boot operating environment.

### DESCRIPTION OF THE DRAWINGS

Features of exemplary implementations of the invention will become apparent from the description, the claims, and the accompanying drawings in which:

FIG. 1 is a representation of one exemplary implementation of an apparatus that comprises a computer component, one or more input components, and one or more display components.

FIG. 2 is a representation of one exemplary implementation of a graphical user interface provided by the display component of the apparatus of FIG. 1.

### DETAILED DESCRIPTION

Referring to the BACKGROUND section above, present operating systems operate with resource overhead, for example, excess memory allocation and processor usage, for execution of file management procedures. Before the operating system loads, a pre-boot operative environment provides procedures for functionality to diagnose, configure, and/or manipulate computer hardware. An exemplary pre-boot operating environment comprises an extensible firmware interface (“EFI”) offered by Intel Corp. (Santa Clara, Calif. 95052, http://www.intel.com/technology/efi/). The pre-boot operating environment does not provide functionality for multiple tasks, multiple users, or complex applications. So, the pre-boot operating environment allocates fewer resources than an operating system. The reduction in resource requirements results in a corresponding reduction in load time for the pre-boot operating environment. For an additional reduction in resource allocation, the pre-boot operating environment employs a command line interface for interactions with the user. For example, the user enters commands via a keyboard. Undesirably, employment of the command line-interface is time-consuming and requires knowledge of a correct syntax for the commands.

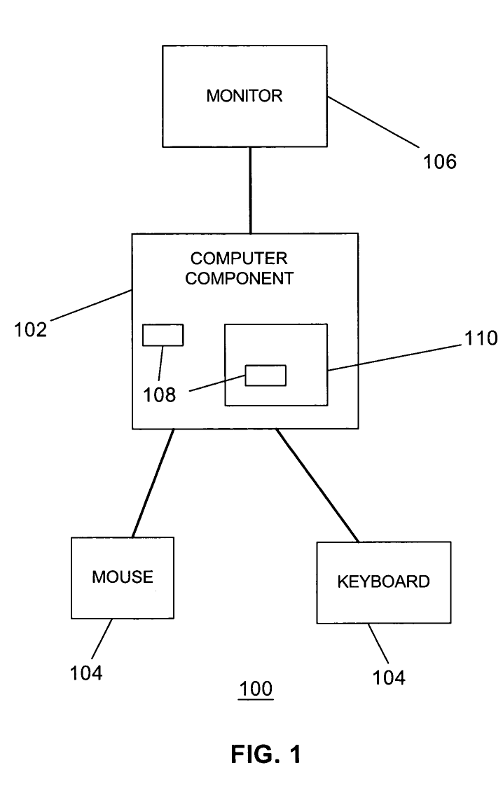

Turning to FIG. 1, an apparatus 100 in one example comprises a computer component 102, one or more input components 104, and one or more display components 106. The computer component 102 in one example comprises a network server, workstation, or personal computer. In a further example, the computer component 102 comprises an instance of a recordable data storage medium 108, as described herein. The computer component 102 comprises one or more software, firmware, and/or hardware components, for example, file storage components 110. Exemplary file storage components 110 comprise floppy disk drives, hard disk drives and/or controllers, CD-ROM drives, tape drives, network storage devices, and memory devices.

For configuration and/or communication with the file storage components 110, the computer component 102 employs a pre-boot operating environment. An exemplary pre-boot operating environment comprises the extensible firmware interface operating environment. The computer component 102 and/or the file storage components 110 store the pre-boot operating environment, for example, on the recordable data storage medium 108. The pre-boot operating environment in one example comprises an interface between one or more operating systems loaded by the computer component 102 and one or more firmware components of the computer component 102. The pre-boot operating environment employs a command line interface for interaction with a user (not shown). The pre-boot operating environment comprises one or more procedures, for example, file management procedures, to communicate with the file storage components 110. Exemplary file management procedures comprise procedures for navigating one or more file volumes, creating directories, listing file contents of a directory, copying, deleting, and changing attributes. Where the pre-boot operating environment comprises the extensible firmware interface, exemplary file management procedures comprise “cd,” “mkdir,” “Is,” “cp,” “rm,” and “attrib,” respectively.

The file storage components 110 in one example comprise one or more procedures that are specialized for the file storage component 110. In one example where the file storage component 110 comprises a floppy disk drive, the file storage component 110 comprises a procedure for unmounting the volume. In another example where the file storage component 110 comprises a hard disk controller, the file storage component 110 comprises a procedure for aggregating a plurality of disks in a redundant array of independent/inexpensive disks (“RAID”) configuration or adjusting I/O throughput settings. In a further example, the hard disk controller comprises one or more procedures for additional configuration of itself, the plurality of disks it controls, or diagnostics.

The file storage components 110 in one example comply with the pre-boot operating environment. For example, the procedures of the file storage components 110 are compatible with the pre-boot operating environment. In a further example, the file storage components 110 comply with a file allocation table file system standard, for example, “FAT”, “FAT12”, “FAT16”, or “FAT32”. For example, where the file storage component 110 comprises a hard disk drive, the drive is formatted according to the FAT file system standard. Other file system standards may also be supported by the pre-boot operating environment either natively or through an operating environment extension, as will be appreciated by those skilled in the art. The file storage component 110 comprises one or more file contents that are readable by the pre-boot operating environment. The file storage components 110 in one example comprise an instance of a recordable data storage medium 108, as described herein. For example, the recordable data storage medium 108 comprises one or more procedures of the file storage component 110.

The input components 104 in one example comprise a keyboard, mouse, or touch screen. The computer component 102 employs the input components 104 to receive one or more inputs from the user. Exemplary inputs comprise typed commands, keystrokes, and mouse clicks. In one example, the input components 104 are remotely located from the computer component 102. For example, the computer component 102 receives the inputs from a remote input component over a data network.

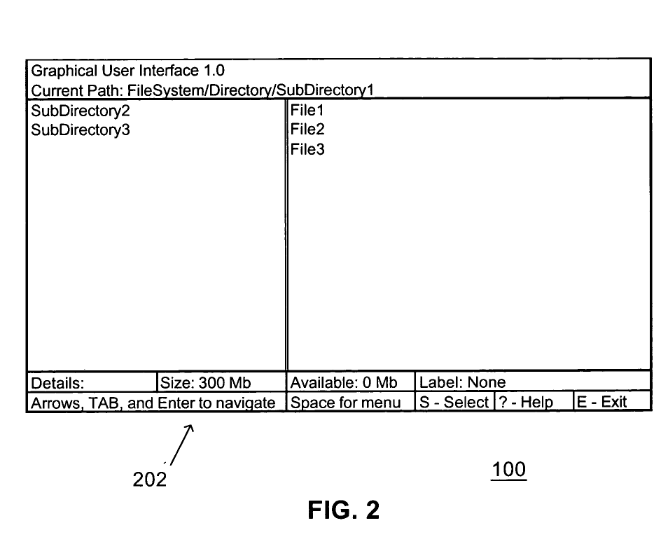

The display component 106 in one example comprises a computer monitor or liquid crystal display (“LCD”). The computer component 102 employs the display component 106 to display information to the user. For example, the computer component 102 displays a graphical user interface 202 (FIG. 2) to the user through employment of the display component 106. The computer component 102 employs the graphical user interface 202 for interactions with the user. In one example, the output components 106 are remotely located from the computer component 102. For example, the computer component 102 sends the graphical user interface 202 over a data network to a remote output component 106 for display to the user.

Turning to FIG. 2, the graphical user interface 202 in one example comprises graphics and/or text. The graphics and/or text in one example comply with a computer graphics standard, for example, video graphics adapter (“VGA”) or universal graphics adapter (“UGA”). Exemplary graphics comprise bitmaps, graphic interchange format (“GIF”) files, and other digital media files, as will be appreciated by those skilled in the art. In one example, the graphics and/or text simulate one or more bitmaps. In another example, the graphical user interface 202 employs the graphics and/or text to display one or more user interface components, for example, checkboxes, combo boxes, progress bars, tabs, and window frames, as will be appreciated by those skilled in the art. The graphical user interface 202 employs the graphics and/or text to provide a shell to the user. The graphical user interface 202 in one example is a program written in a programming language that is native to the pre-boot operating environment, for example, EFI. The graphical user interface 202 provides an interface to one or more procedures of the pre-boot operating environment.

An illustrative description of exemplary operation of the apparatus 100 is presented, for explanatory purposes. Upon startup of the computer component 102, the computer component 102 performs a power on self test (“POST”) and loads the pre-boot operating environment. The computer component 102 employs the command line interface of the pre-boot operating environment for interaction with the user. For example, the computer component 102 receives inputs through the command line interface from the input component 104, as will be appreciated by those skilled in the art. In another example, the computer component 102 employs a boot manager menu that shows a list of bootable devices, for example, hard drives, read-only memory components (“ROM”), and the command line interface.

The computer component 102 loads the graphical user interface 202 upon request of the user. The graphical user interface 202 in one example comprises a program that is invoked by a command “drive_explorer.” The user inputs “drive_explorer” to the command line interface of the pre-boot operating environment, and the computer component 102 loads the graphical user interface 202. The file storage component 110 and/or computer component 102 in one example store the graphical user interface 202 as a software and/or firmware program. The software and/or firmware program is available to the user if the file storage component 110 is readable by the pre-boot operating environment.

The graphical user interface 202 in one example employs one or more pre-determined “hotkeys” for interaction with the user. The pre-determined hotkey corresponds to a procedure to be performed by the graphical user interface 202, as will be appreciated by those skilled in the art. In one example, the user inputs an “S” to cause a selection of a file. In another example, the user inputs an “E” to execute a selected file. Other pre-determined hotkeys are possible, as will be apparent to those skilled in the art.

The graphical user interface 202 in one example comprises one or more menus for interaction with the user. The menus comprise one or more menu items that correspond to a procedure to be performed by the graphical user interface 202, as will be appreciated by those skilled in the art. The menus and/or menu items in one example comprise pre-determined menus and/or pre-determined menu items. In one example, the user selects a “File” menu item and then an “Exit” menu item, which exits the graphical user interface 202. Other menus and menu items are possible, as will be apparent to those skilled in the art.

The graphical user interface 202 in one example employs one or more default values for one or more of the procedures. For example, when performing a directory listing procedure, the graphical user interface 202 employs a default value to obtain all files (e.g., including hidden files) in the directory with their respective attributes. In another example, the graphical user interface 202 employs a dynamic value for a procedure. For example, where the user had made a selection that comprises a file, the graphical user interface 202 employs the file as a value to a procedure, for example, a delete procedure. Other default values are possible, as will be apparent to those skilled in the art. In one example, the graphical user interface 202 provides one or more options for the user to change the default values.

The graphical user interface 202 in one example displays information based on the file storage components 110. Where the file storage component 110 comprises a hard disk drive, the graphical user interface 202 displays a directory listing of the hard disk drive. For example, the graphical user interface 202 displays a name, a size, a timestamp, and permissions for one or more files of a directory. The graphical user interface 202 navigates through the file contents of the file storage component 110 based on the user's input. The graphical user interface 202 in one example allows the user to make a selection based on a current display of the graphical user interface 202. For example, the graphical user interface 202 selects a file of the directory listing based on the user's input. In a further example, the graphical user interface 202 highlights the selection on the current display to indicate the selection.

The graphical user interface 202 in one example displays a list of currently available procedures of the pre-boot operating environment. In a further example, upon selection of a file or directory by the user, the graphical user interface 202 displays and/or hides one or more of procedures, hotkeys, menu items, and/or information related to the selection. For example, upon selection of a file, the graphical user interface 202 displays a size of the file, a modification date of the file, and a hotkey to edit the file. In another example, upon selection of a hard disk drive, the graphical user interface 202 displays a capacity of the hard disk drive, a number of directories on the hard disk drive, and a label of the hard disk drive. The graphical user interface 202 may display information related to several procedures simultaneously. For example, the graphical user interface 202 displays a path to a directory, a listing of files within the directory, file attributes of the files, and a size of the directory.

The graphical user interface 202 in one example obtains one or more of the procedures from the pre-boot operating environment. In one example, the graphical user interface 202 obtains file management procedures from the pre-boot operating environment, for example, a procedure library. The procedure library comprises a native library of the pre-boot operating environment and/or an operating environment extension. The graphical user interface 202 in one example sends one or more requests for procedures to the pre-boot operating environment. The pre-boot operating environment in one example sends the procedures to the graphical user interface 202 in response to the request. In another example, the pre-boot operating environment returns one or more memory addresses of the procedures to the graphical user interface 202, as will be appreciated by those skilled in the art.

In another example, the graphical user interface 202 obtains one or more of the procedures from the file storage components 110. For example, the graphical user interface 202 obtains diagnostic procedures and/or configuration procedures from the recordable data storage medium 108 of the file storage component 110. The graphical user interface 202 in one example sends one or more requests for procedures to the file storage component 110. The file storage component 110 in one example sends the procedures to the graphical user interface 202 in response to the request. In another example, the file storage components 110 return one or more memory addresses of the procedures to the graphical user interface 202, as will be appreciated by those skilled in the art.

The apparatus 100 in one example comprises a plurality of components such as one or more of electronic components, hardware components, and computer software components. A number of such components can be combined or divided in the apparatus 100. An exemplary component of the apparatus 100 employs and/or comprises a set and/or series of computer instructions written in or implemented with any of a number of programming languages, as will be appreciated by those skilled in the art. The apparatus 100 in one example comprises any (e.g., horizontal, oblique, or vertical) orientation, with the description and figures herein illustrating one exemplary orientation of the apparatus 100, for explanatory purposes.

The apparatus 100 in one example employs one or more computer-readable signal-bearing media. An exemplary computer-readable signal-bearing medium for the apparatus 100 comprises the recordable data storage medium 108 of the computer component 102. For example, the computer-readable signal-bearing medium for the apparatus 100 comprises one or more of a magnetic, electrical, optical, biological, and atomic data storage medium. In one example, the computer-readable signal-bearing medium comprises a modulated carrier signal transmitted over a network comprising or coupled with the apparatus 100, for instance, one or more of a telephone network, a local area network (“LAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. An apparatus, comprising:
a graphical user interface employable for one or more file management procedures of a pre-boot operating environment employable with a command line interface.

2. The apparatus of claim 1, wherein the graphical user interface allows input from the user to cause one or more of selection and execution of one or more of the one or more file management procedures.

3. The apparatus of claim 2, wherein the graphical user interface receives input from the user that corresponds to a pre-determined hotkey, wherein the graphical user interface determines that the input from the user corresponds to the pre-determined hotkey, wherein the graphical user interface employs the input from the user to cause the one or more of selection and execution of one or more of the one or more file management procedures.

4. The apparatus of claim 2, wherein the graphical user interface receives input from the user that corresponds to a pre-determined menu item, wherein the graphical user interface determines that the input from the user corresponds to the pre-determined menu item, wherein the graphical user interface employs the input from the user to cause the one or more of selection and execution of one or more of the one or more file management procedures.

5. The apparatus of claim 1, wherein the graphical user interface communicates with one or more file storage components through employment of one or more of the one or more file management procedures.

6. The apparatus of claim 5 in combination with the one or more file storage components, wherein the one or more file storage components comprise one or more file contents that are readable by the pre-boot operating environment.

7. The apparatus of claim 6, wherein the one or more file storage components comply with a file allocation table file system standard that comprises one of FAT, FAT12, FAT16, and FAT32;
wherein the graphical user interface employs the file system standard to display information based on the one or more file contents of the one or more file storage components.

8. The apparatus of claim 6, wherein the one or more file storage components comply with a file system standard that is natively supported by the pre-boot operating environment, wherein one or more of the one or more file management procedures comply with the file system standard, wherein the graphical user interface employs the one or more of the one or more file management procedures to display information based on the one or more file contents of the one or more file storage components.

9. The apparatus of claim 6, wherein the one or more file storage components comply with a file system standard that is supported by the pre-boot operating environment through employment of an operating environment extension, wherein one or more of the one or more file management procedures comply with the file system standard, wherein the graphical user interface employs the one or more of the one or more file management procedures to display information based on the one or more file contents of the one or more file storage components.

10. The apparatus of claim 5, wherein the graphical user interface obtains one or more of the one or more file management procedures from one or more of:
the pre-boot operating environment; and
the one or more file storage components.

11. The apparatus of claim 10, wherein the graphical user interface sends one or more requests to the one or more of the pre-boot operating environment and the one or more file storage components, wherein the graphical user interface receives the one or more of the one or more file management procedures from the one or more of the pre-boot operating environment and the one or more file storage components in response to the one or more requests.

12. The apparatus of claim 10, wherein the graphical user interface displays a list of currently available procedures of the one or more file storage components.

13. The apparatus of claim 5, wherein the file storage components comprise one or more file contents, wherein the graphical user interface employs one or more of the one or more file management procedures to navigate through the one or more file contents.

14. The apparatus of claim 13, wherein the graphical user interface employs the one or more of the one or more file management procedures to one or more of manipulate and execute one or more of the one or more files of the one or more file storage components.

15. The apparatus of claim 13, wherein the graphical user interface employs the one or more of the one or more file management procedures to one or more of manipulate and execute one or more of:
one or more configurations of the file storage component; and
one or more diagnostics of the file storage component.

16. The apparatus of claim 1, wherein the graphical user interface displays a list of currently available procedures of the pre-boot operating environment.

17. The apparatus of claim 16, wherein the graphical user interface displays a list of currently available procedures of the pre-boot operating environment based on a current selection.

18. The apparatus of claim 1, wherein the graphical user interface comprises a shell with one or more of graphics and text.

19. The apparatus of claim 18, wherein the graphical user interface indicates one or more of:
one or more pre-determined hotkeys; and
one or more pre-determined menus;
through employment of the one or more of graphics and text.

20. The apparatus of claim 1, wherein the graphical user interface comprises one or more of computer software and computer firmware that is native to the pre-boot operating environment.

21. The apparatus of claim 1 in combination with the pre-boot operating environment, wherein the pre-boot operating environment comprises an interface between one or more operating systems and one or more firmware components.

22. The apparatus of claim 1 in combination with the pre-boot operating environment, wherein the pre-boot operating environment comprises an extensible firmware interface (EFI) operating environment.

23. A method, comprising the step of:
invoking a graphical user interface through a command line interface for one or more file management procedures of a pre-boot operating environment.

24. The method of claim 23, further comprising the step of:
communicating with one or more file storage components through employment of the graphical user interface.

25. The method of claim 24, wherein the step of communicating with the one or more file storage components through employment of the graphical user interface comprises the step of:
obtaining one or more of the one or more file management procedures from one or more of the one or more file storage components and the pre-boot operating environment.

26. The method of claim 24, further comprising the step of:
manipulating one or more files of the file storage component through employment of the graphical user interface.

27. The method of claim 24, further comprising the step of:
executing one or more files of the file storage component through employment of the graphical user interface.

28. The method of claim 24, further comprising the step of:
navigating through one or more files of the file storage component through employment of the graphical user interface.

29. The method of claim 23, further comprising the step of:
providing to a user a shell for the one or more file management procedures of the pre-boot operating environment.

30. An article, comprising:
one or more computer-readable signal-bearing media; and
means in the one or more media for invoking a graphical user interface through a command line interface for one or more file management procedures of a pre-boot operating environment.

31. The article of claim 30, further comprising:
means in the one or more media for communicating with one or more file storage components through employment of the graphical user interface.

32. The article of claim 31, wherein the means in the one or more media for communicating with the one or more file storage components through employment of the graphical user interface comprises:
means in the one or more media for obtaining one or more of the one or more file management procedures from one or more of the one or more file storage components and the pre-boot operating environment.

33. The article of claim 31, further comprising:
means in the one or more media for manipulating one or more files of the file storage component through employment of the graphical user interface.

34. An apparatus, comprising:
means for invoking a graphical user interface through a command line interface for one or more file management procedures of a pre-boot operating environment.

35. The apparatus of claim 34, further comprising:
means for communicating with one or more file storage components through employment of the graphical user interface.

36. The apparatus of claim 35, wherein the means for communicating with the one or more file storage components through employment of the graphical user interface comprises:
means for obtaining one or more of the one or more file management procedures from one or more of the one or more file storage components and the pre-boot operating environment.

37. The apparatus of claim 35, further comprising:
means for manipulating one or more files of the file storage component through employment of the graphical user interface.
